(19) United States
(12) Patent Application Publication
(10) Pub. No.: US 2017/0330428 A1
(43) Pub. Date: Nov. 16, 2017

(54) Multi-Functional Sensors For Sensor Devices

(71) Applicants: Christopher Lee Bohler, Peachtree City, GA (US); Scott David Wegner, Peachtree City, GA (US)

(72) Inventors: Christopher Lee Bohler, Peachtree City, GA (US); Scott David Wegner, Peachtree City, GA (US)

(21) Appl. No.: 15/287,164

(22) Filed: Oct. 6, 2016

Related U.S. Application Data
(60) Provisional application No. 62/241,861, filed on Oct. 15, 2015.

(51) Int. Cl. G08B 5/36

(52) U.S. Cl. CPC G08B 5/36

(57) ABSTRACT

A sensor device is disclosed herein. The sensor device can include a sensor having a first mode of operation and a second mode of operation, wherein the sensor, when in the first mode of operation, transmits a first plurality of signals during a first period of time, and wherein the sensor, when in the second mode of operation, receives a second plurality of signals during a second period of time.

### CROSS-REFERENCE TO RELATED APPLICATIONS

This application claims priority under 35 U.S.C. §119 to U.S. Provisional Patent Application Ser. No. 62/241,861, titled “Multi-Functional Sensors For Sensor Devices” and filed on Oct. 15, 2015, the entire contents of which are hereby incorporated herein by reference.

### TECHNICAL FIELD

Embodiments described herein relate generally to sensor devices used in spaces, and more particularly to systems, methods, and devices for multi-functional sensors for sensor devices.

### BACKGROUND

Sensor devices are used in a variety of applications. For example, sensor devices are used for energy management. In such a case, the sensor device can be placed in a space (e.g., a room) and can measure one or more of a number of parameters within the space. Such parameters can include, but are not limited to, an amount of ambient light and movement. Thus, a sensor device can include one or more of a number of sensors. Examples of sensors that are included in a sensor device can include, but are not limited to, a photo sensor and an infrared detector. Each sensor is designed to perform one function, so when multiple functions are required, multiple sensors are used on a single sensor device.

In addition, or in the alternative, a sensor device can include one or more of a number of other components. For example, a sensor device can include an indicating light to let a user know whether the sensor device is operating properly. As a result, a sensor device can have a significant footprint when mounted on a surface (e.g., a ceiling of a room, a wall of a room) or on an electrical device (e.g., a light fixture). Each sensor and each other component operate independently of each other.

### SUMMARY

In general, in one aspect, the disclosure relates to a sensor device. The sensor device can include a sensor having a first mode of operation and a second mode of operation, where the sensor, when in the first mode of operation, transmits a first number of signals during a first period of time, and where the sensor, when in the second mode of operation, receives a second number of signals during a second period of time.

In another aspect, the disclosure can generally relate to a sensor for a sensor device. The sensor can include a light-emitting diode (LED) having a first mode of operation and a second mode of operation, where the LED, when in the first mode of operation, transmits a first number of signals during a first period of time, and where the sensor, when in the second mode of operation, receives a second number of signals during a second period of time.

In yet another aspect, the disclosure can generally relate to an electrical device. The electrical device can include a functional component, and a controller coupled to the functional component. The electrical device can also include a sensor device coupled to the controller. The sensor device can include a sensor having a first mode of operation and a second mode of operation, where the sensor, when in the first mode of operation, transmits a first number of signals during a first period of time, and where the sensor, when in the second mode of operation, receives a second number of signals during a second period of time. The These and other aspects, objects, features, and embodiments will be apparent from the following description and the appended claims.

### BRIEF DESCRIPTION OF THE DRAWINGS

The drawings illustrate only example embodiments of multi-functional sensors for sensor devices and are therefore not to be considered limiting of its scope, as multi-functional sensors for sensor devices may admit to other equally effective embodiments. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

FIGS. 1A and 1B show various portions of a sensor device currently known in the art.

FIG. 2 shows a circuit board assembly that includes a multi-function sensor in accordance with certain example embodiments.

FIG. 3 shows a graph showing the performance of a multi-function sensor in accordance with certain example embodiments.

FIG. 4 shows a system diagram that includes a controller for use with a multi-function sensor in accordance with certain example embodiments.

FIG. 5 shows a computing device in accordance with one or more example embodiments.

### DETAILED DESCRIPTION OF EXAMPLE EMBODIMENTS

The example embodiments discussed herein are directed to systems, apparatuses, and methods of multi-functional sensors for sensor devices. While example embodiments described herein are directed to use with lighting systems, example embodiments can also be used in systems having other types of devices. Examples of such other systems can include, but are not limited to, security systems, fire protection systems, and emergency management systems. Thus, example embodiments are not limited to use with lighting systems. Further, while example embodiments are described as being integrated with or in direct communication with a lighting fixture, example embodiments can also be integrated with or in direct communication with any other electrical device. Examples of such other electrical devices can include, but are not limited to, a thermostat, a wall switch, a heating, ventilation, and air conditioning (HVAC) system, an electrical receptacle, a fire control panel, and a shade control device.

As described herein, a user can be any person that interacts with sensor devices. Examples of a user may include, but are not limited to, a consumer, an electrician, an engineer, a mechanic, a pipe fitter, an instrumentation and control technician, a consultant, a contractor, an operator, and a manufacturer's representative. For any figure shown and described herein, one or more of the components may be omitted, added, repeated, and/or substituted. Accordingly, embodiments shown in a particular figure should not be considered limited to the specific arrangements of components shown in such figure.

Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three or four digit number and corresponding components in other figures have the identical last two digits.

In certain example embodiments, the sensor devices that include example multi-functional sensors (or portions thereof) described herein meet one or more of a number of standards, codes, regulations, and/or other requirements established and maintained by one or more entities. Examples of such entities include, but are not limited to, Underwriters' Laboratories (UL), the Institute of Electrical and Electronics Engineers (IEEE), International Electrotechnical Commission (IEC) and the National Fire Protection Association (NFPA). For example, wiring (the wire itself and/or the installation of such wire) that electrically couples a sensor devices that includes an example light guide with a light fixture may fall within one or more standards set forth in the National Electric Code (NEC). In such a case, the NEC defines Class 1 circuits and Class 2 circuits under various Articles, depending on the application of use.

Example embodiments of multi-functional sensors for sensor devices will be described more fully hereinafter with reference to the accompanying drawings, in which example embodiments of multi-functional sensors for sensor devices are shown. Multi-functional sensors for sensor devices may, however, be embodied in many different forms and should not be construed as limited to the example embodiments set forth herein. Rather, these example embodiments are provided so that this disclosure will be thorough and complete, and will fully convey the scope of multi-functional sensors for sensor devices to those of ordinary skill in the art. Like, but not necessarily the same, elements (also sometimes called components) in the various figures are denoted by like reference numerals for consistency.

Terms such as “first”, “second”, “top”, “bottom”, “side”, “inner”, “outer”, “proximal”, and “distal” are used merely to distinguish one component (or part of a component or state of a component) from another. Such terms are not meant to denote a preference or a particular orientation, and are not meant to limit embodiments of light guides for sensor devices. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

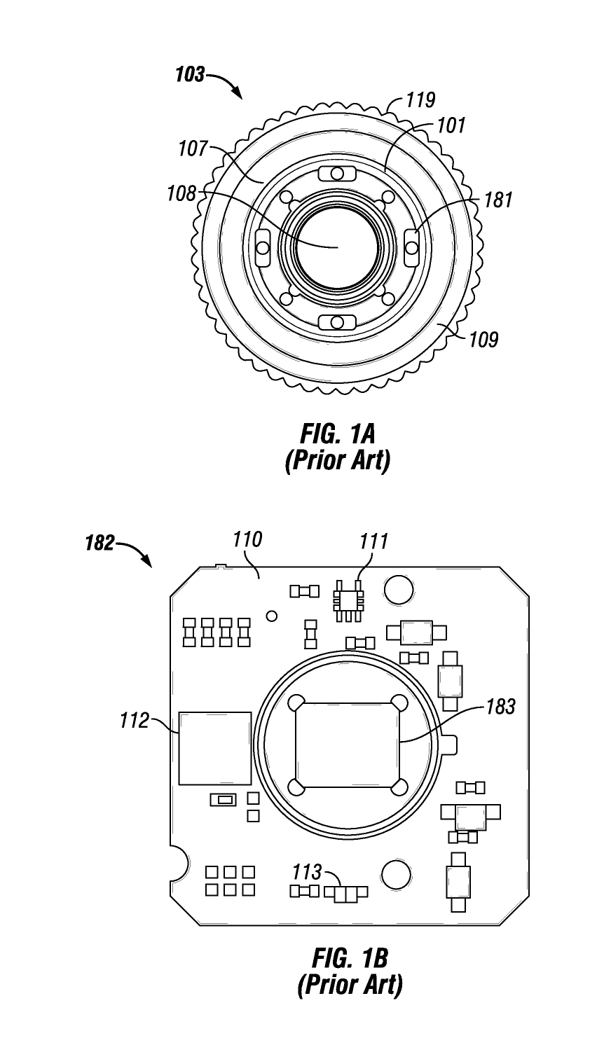

FIGS. 1A and 1B show various portions of a sensor device 103 currently known in the art. Specifically, FIG. 1A shows a top view of a sensor device 103. FIG. 1B shows a top view of a circuit board assembly 182 of the sensor device 103. Referring to FIGS. 1A and 1B, the circuit board assembly 182 is disposed within a housing (hidden from view by the trim 119) of the sensor device 103. The circuit board assembly 182 can include circuit board 110 on which are disposed one or more of a number of components. Examples of such components can include, but are not limited to, a resistor, a capacitor, an integrated circuit, a photo sensor 111, an infrared detector 112, an occupancy sensor 183, and a light-emitting diode (LED) 113. For purposes of this application, each of the components that emit an output based on a response to physical, electrical, chemical, thermal, spectral, and/or other changes in a space (in this case, the photo sensor 111, the infrared detector 112, the occupancy sensor 183, and the LED 113) can be called a sensor.

The sensor device 103 includes an inner body 107 and a trim 119 that is movably (e.g., threadably) coupled to the inner body 107. The trim 119 can be used to hold one or more components of the sensor device 103 in place. For example, the trim 119 can be used to retain the light guide 101, which includes a number of channels 181 that are aligned with a sensor (e.g., photo sensor 111, infrared detector 112, occupancy sensor 183, LED 113) disposed on the circuit board 110. In this example, the light guide 101 has four separate channels 181 that are located at different points.

As a result of the multiple sensors in the sensor device 103, the footprint of the sensor device 103 is large and protruding. In addition, the number of features of the sensor device 103 that are visible to a user is high. Consequently, sensor devices currently used in the art, such as sensor device 103, lack in aesthetic appeal. The sensor device 103 can be mounted in any of a number of places relative to an electrical device (e.g., a light fixture). For example, the sensor device 103 can be integrated with an electrical device. As a specific example, when the electrical device is a light fixture, the sensor device 103 can be disposed on a center panel or an outer panel.

As discussed above, each sensor of the sensor device 103 performs its own function independently of the other sensor of the sensor device 103. For example, the photo sensor 111 (e.g., a silicon photodiode) detects daylight, the infrared detector 112 detects a signal from a remote control device, the occupancy sensor 183 is a far infrared detector that detects motion, and the LED 113 emits light that can be seen by a user, Example embodiments use a single sensor to perform multiple functions that are currently performed by multiple sensors on a sensor device. As a result, the footprint of a sensor device can be greatly reduced relative to sensor devices currently used in the art.

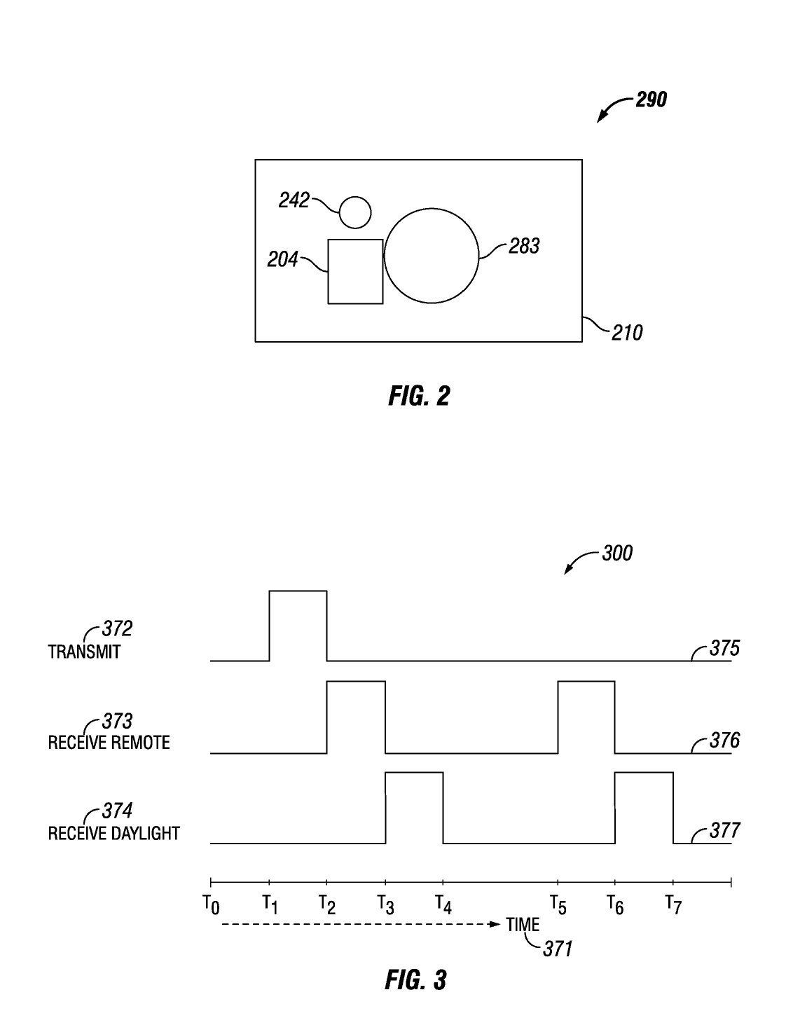

FIG. 2 shows an outline of a circuit board assembly 290 that includes a multi-function sensor 242 in accordance with certain example embodiments. Referring to FIGS. 1A-2, the circuit board assembly 290 can include circuit board 210 on which are disposed the example multi-function sensor 242 (also called, more simply, an example sensor 242 or a sensor 242), a controller 204, and an occupancy sensor 283. In this case, the circuit board 210 of FIG. 2 is substantially the same as the circuit board 110 of FIG. 1B, except that the circuit board 210 of FIG. 2 is smaller than the circuit board 110. Also, the occupancy sensor 283 of FIG. 2 is substantially the same as the occupancy sensor 183 of FIG. 1B.

The sensor 242 of FIG. 2 can perform a number of functions. For example, the sensor 242 can emit light as an indication of status to a user, detect and/or measure daylight, and send signals to and/or receive signals from a remote device. As shown below with respect to FIG. 3, the functions performed by the sensor 242 are separated temporally (by time 371). Specifically, the graph 300 of FIG. 3 shows that the sensor 242 can transmit 372 (in this case, emit light as an indication of status to a user), receive remote 373 (send signals to and/or receive signals from a remote device), and receive daylight 374 (detect and/or measure daylight). Plot 375 shows the status of the transmit mode 372, plot 376 shows the status of the receive remote mode 373, and plot 377 shows the status of the receive daylight mode 374 over time 371.

Referring to FIGS. 1A-3, the graph 300 of FIG. 3 shows that at time T₀, the sensor 242 is inactive. At time T₁, the sensor 242 enters transmit mode 372 (emits light) until time T₂, when the sensor 242 stops transmit mode 372 (stops emitting light) and starts receive remote mode 373. The sensor 242 continues in receive remote mode 373 until time T₃, when the sensor 242 stops receive remote mode 373 and starts receive daylight mode 374. The sensor 242 continues in receive daylight mode 374 until time T₄, when the sensor 242 stops receive daylight mode 374 and remains inactive until time T₅. At time T₅, the sensor 242 again starts receive remote mode 373, which continues until time T₆, when the sensor 242 stops receive remote mode 373 and again starts receive daylight mode 374. The sensor 242 continues in receive daylight mode 374 until time T₇, at which point the sensor 242 again becomes inactive. The total amount of time 371 shown in the graph 300 of FIG. 3 can be any amount of time. For example, the total amount of time 371 can be one millisecond.

In certain example embodiments, the controller 204 is communicably coupled to the sensor 242 and controls the temporal activation of the various multiple functions performed by the sensor 242. In addition, the controller 204 can interpret signals received by the sensor 242 and use that interpretation to control one or more electrical devices or components thereof. The controller 204 can include one or more integrated circuits (ICs), one or more of a number of discrete components (e.g., resistors, capacitors, diodes), and/or any other suitable components. The controller can also be communicably coupled to the occupancy sensor 283.

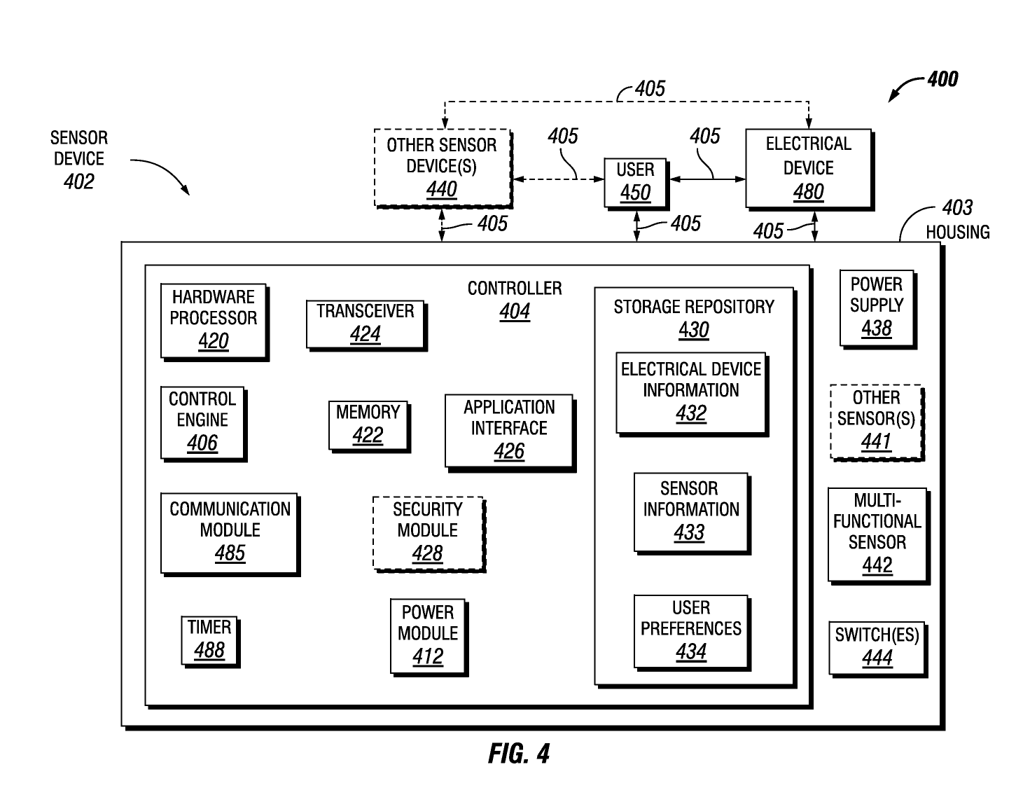

FIG. 4 shows a system diagram of a system 400 that includes a controller 404 for use with multi-function sensor 442 in accordance with certain example embodiments. The sensor 442 can be part of a sensor device 402. In addition to the sensor device 402, the system 400 of FIG. 4 can include one or more electrical devices 480, a user 450, and one or more optional other sensor devices 440. In addition to the sensor 442, the sensor device 402 can include a controller 404, a power supply 438, one or more switches 444, and one or more optional other sensors 441. The controller 404 can include one or more of a number of components. Such components, can include, but are not limited to, a control engine 406, a communication module 485, a timer 488, a storage repository 430, a hardware processor 420, a memory 422, a transceiver 424, an application interface 426, and, optionally, a security module 428.

The components shown in FIG. 4 are not exhaustive, and in some embodiments, one or more of the components shown in FIG. 4 may not be included in an example sensor device 402. Any component of the example sensor device 402 can be discrete or combined with one or more other components of the sensor device 402. In addition, the location of one or more components can vary from what is shown in FIG. 4. For example, the sensor device sensor device 402 may not have a local controller 404. Instead, the controller 404 can be located remotely from the sensor device 402 and communicate with the sensor 442 using communication links 405. As another example, the switches 444 can be part of the controller 404 rather than separate components.

The user 450 is the same as a user defined above. The user 450 interacts with (e.g., sends data to, receives data from) the controller 404 of the sensor device 402 via the application interface 426 (described below). The user 450 can also interact with one or more optional other sensor devices 440 and/or one or more electrical devices 480. Interaction between the user 450 and the sensor device 402, the other sensor devices 440, and the electrical devices 480 can be conducted using communication links 405. The communication links 405 can transmit signals (e.g., communication signals, control signals, data) between the sensor device 402 and the user 450, one or more other sensor devices 440, and/or one or more of the electrical devices 480.

An electrical device 480 can be any device that operates using a form of electrical energy. An electrical device 480 can be a single electrical device, or a grouping of electrical devices. Each electrical device 480 can use one or more of a number of communication protocols. Examples of an electrical device 480 can include, but are not limited to, a wall switch, an electrical receptacle, a HVAC unit, a shade control device, and a light fixture.

An electrical device 480 a functional component that delivers and/or prevents delivery, directly or indirectly, of the output (e.g., light, electrical power, sound, color, shade) for which the electrical device 480 is designed. For example, if the electrical device 480 is a light fixture, the functional component is one or more light sources that emit light. As another example, if the electrical device 480 is a stereo, the functional component can include a speaker (including the associated electronics) through which sound is emitted. As yet another example, if the electrical device 480 is a wall outlet, the functional component can include a switch (e.g., a breaker, a contactor, a relay) that can open or close to prevent or allow power to flow. The functional component of an electrical device 480 can control delivery of more than one output. In some cases, an electrical device 480 can have multiple functional components. The functional component of an electrical device 480 can be controlled by the controller 404 (or some other controller), where such control can be based, at least in part, on data transmitted from and/or received by the example sensor 442.

An electrical device 480 can include and/or be coupled to the controller 404 and/or the sensor device 402. The sensor 442 of the sensor device 402 can monitor conditions in and/or around the electrical device 480. Examples of such conditions can include, but are not limited to, a level of ambient light, the presence of a person, the identity of a person, identification of smoke before a fire starts, a fire, movement of a person, color tuning, traffic flow within a space, and a comparison of natural and ambient light.

As a result, as discussed above, the sensor 442, when coupled with the controller 404, can eliminate a number of sensors that are used in the art today. Such sensors can include, but are not limited to, a photocell, an infrared light detector, a thermometer, a smoke detector, a scanner, and an acoustic detector. In certain example embodiments, the sensor 442 is not integrated with an electrical device 480, but is rather a stand-alone device that is communicably coupled with the controller 404. The multi-functional sensor 442 is configured to both send and receive signals.

The sensor 442 can use one or more of a number of transceiving technologies. For example, the sensor 442 can be a LED that sends and receives light waves. In such a case, the LED could emit higher wavelengths (e.g., between 460 nm and 780 nm) compared to the wavelengths (e.g., between 380 nm and 460 nm, which corresponds to white, violet, blue, near-ultraviolet (UV), and UV) received by the LED. This would mean that, based on current technology, the LED could not detect IR waves, and so any devices (e.g., a user-controlled remote control device) that currently send IR signals to a sensor of a sensor device could be modified to send white, blue, violet, or bluetooth (e.g., LED, laser, radio frequency) signals so that an example sensor 442 of the sensor device 402 can function properly.

Furthering this example, when the sensor 442 is a LED, the LED can include a semi-conductor having a p-n junction. In such a case, when forward biasing (electrical energy) is applied to the p-n junction, the electrons from the n region cross over to recombine with the holes in the p region, creating photons. Since the energy level of the holes in the p region are less than the energy level of the electrons in the n region, excess energy from the electrons are emitted during the recombination process. This excess energy is emitted in the form of visible light, and so the LED can act as a light source (emitter) when forward biasing is applied to it.

By contrast, when reverse biasing is applied to the p-n junction, the photons in the p region are broken apart so that the electrons are separated out to create holes in the p region. The after being separate from the photons, the electrons travel from the p region to the n region, creating current. The amount of current generated by the electrons is based on amount of light detected at the p-n junction. In this way, the LED can act as a photo detector when reverse biasing is applied to it.

The sensor 442 can be located at any of a number of locations with respect to the sensor device 402 and/or an electrical device 480. For example, the sensor 442 can disposed in an outer surface of an electrical device (e.g., in the trim of a light fixture). As another example, the sensor 442 can be disposed within an electrical device (e.g., through the backplane of a light fixture, behind the diffuser of a recessed luminaire). Alternatively, the sensor 442 can be located remotely from the sensor device 402 and the electrical device 480.

In certain example embodiments, the sensor 442 performs the function of an occupancy sensor (e.g., a photo detector). In such a case, the occupancy sensor function of the sensor 442 would be turned off intermittently in favor of other functions (e.g., remote signal detection, daylight detection, signal emission) performed by the sensor 442. In such a case, since occupancy sensors traditionally operate at all times, one or more of a number of schemes, controlled by the control engine 406, could be adopted. For example, the control engine 406 could employ a time-of-flight method using visible light when the occupancy function of the sensor 442 is active. The control engine 406 could similarly employ various methods for other sensor functions to compensate for the intermittency of the active period for such other sensor functions. In certain example embodiments, the controller 404 and the sensor 442 can be considered a single, integrated unit rather than separate components of the sensor device 402. In this way, the footprint of the sensor device 402 can be even further reduced.

The sensor 442 can receive power, control, and/or communication signals from the power supply 438. The power supply 438 can send power, control, and/or communication signals to the sensor 442. Examples of a power supply 438 can include, but are not limited to, a driver and a ballast. The power supply 438 can be a source of independent power generation. For example, the power supply 438 can include an energy storage device (e.g., a battery, a supercapacitor). As another example, the power supply 438 can include photovoltaic solar panels. In addition, or in the alternative, the power supply 438 can receive power from an independent power supply. The independent power supply can be any source of power that is independent of the power supply 438. Examples of a power supply can include, but are not limited to, an energy storage device, a feed to a building, a feed from a circuit panel, and an independent generation source (e.g., photovoltaic panels, a heat exchanger).

In certain example embodiments, the power supply 438 sends power, control, and/or communication signals to, and receives power, control, and/or communication signals from, the controller 404 of the sensor device 402. In this way, the controller 404 of the sensor device 402 controls the power supply 438 (and, thus, the sensor 442) of the sensor device 402.

In certain example embodiments, one or more of the switches 444 determine whether forward biasing or reverse biasing is applied to the multi-functional sensor 442 at any point in time. A switch 444 has an open state and a closed state (position). In the open state, the switch 444 creates an open circuit. In such a case, for example, the open switch 444 can allow a forward bias to be applied to the sensor 442 by the power supply 438. In the closed state, the switch 444 creates a closed circuit. In such a case, for example, the closed switch 444 can allow a reverse bias to be applied to the sensor 442 by the power supply 438. Depending on the configuration, a closed switch 444 can allow forward biasing to be applied to the sensor 442, and an open switch 444 can allow reverse biasing to be applied to the sensor 442. In certain example embodiments, the position of each switch 444 is controlled by the control engine 406 of the controller 404.

Each switch 444 can be any type of device that changes state or position (e.g., opens, closes) based on certain conditions. Examples of a switch 444 can include, but are not limited to, a transistor, a dipole switch, a relay contact, a resistor, and a NOR gate. In certain example embodiments, each switch 444 can operate (e.g., change from a closed position to an open position, change from an open position to a closed position) based on input from the controller 404.

The controller 404 of a sensor device 402 can interact (e.g., periodically, continually, randomly) with an electrical device 480, another sensor device 440, and/or the user 450. The user 450, the other sensor devices 440, and/or the electrical devices 480 can interact with the controller 404 of the sensor device 402 using the application interface 426 and the communication links 405 in accordance with one or more example embodiments. Specifically, the application interface 426 of the controller 404 receives data (e.g., information, communications, instructions) from and sends data (e.g., information, communications, instructions) to the user 450, the other sensor devices 440, and/or the other electrical devices 480.

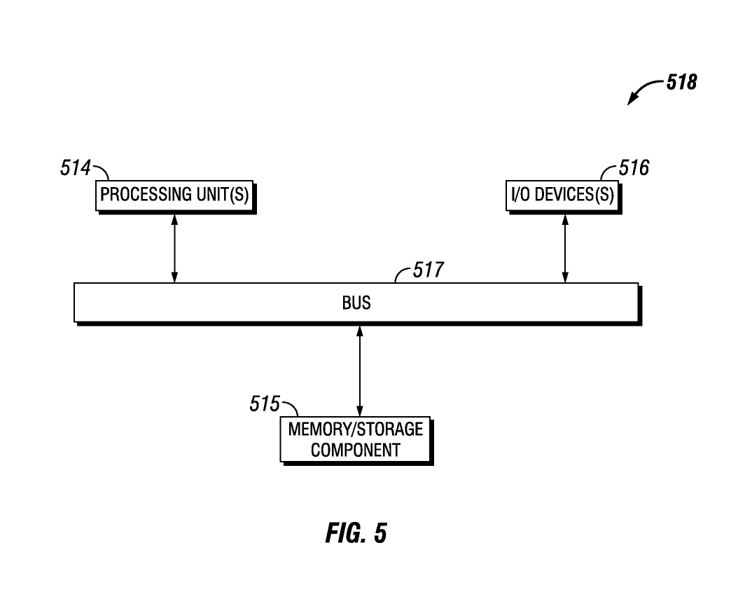

The controller 404, the user 450, the other sensor devices 440, and/or the electrical devices 480 can use their own system or share a system in certain example embodiments. Such a system can be, or contain a form of, an Internet-based or an intranet-based computer system that is capable of communicating with various software. A computer system includes any type of computing device and/or communication device, including but not limited to the controller 404. Examples of such a system can include, but are not limited to, a desktop computer with LAN, WAN, Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 5.

Further, as discussed above, such a system can have corresponding software (e.g., user software, controller software, sensor device software, electrical device software). The software can execute on the same or a separate device (e.g., a server, mainframe, desktop personal computer (PC), laptop, personal desktop assistant (PDA), television, cable box, satellite box, kiosk, telephone, mobile phone, or other computing devices) and can be coupled by the communication network (e.g., Internet, Intranet, Extranet, Local Area Network (LAN), Wide Area Network (WAN), or other network communication methods) and/or communication channels, with wire and/or wireless segments (communication links 405) according to some example embodiments. The software of one system can be a part of, or operate separately but in conjunction with, the software of another system within the system 400.

The sensor device 402 can include a housing 403. The housing 403 can include at least one wall that forms a cavity. The housing 403 of the sensor device 402 can be used to house, at least in part, one or more components (e.g., power supply 438, sensor 442, controller 404) of the sensor device 402, including one or more components of the controller 404. For example, as shown in FIG. 4, the controller 404 (which in this case includes the control engine 406, the communication module 485, the timer 488, the storage repository 430, the hardware processor 420, the memory 422, the transceiver 424, the application interface 426, and the optional security module 428) can be disposed within the cavity formed by the housing 403. In alternative embodiments, any one or more of these or other components of the sensor device 402 can be disposed on the housing 403 and/or remotely from the housing 403.

The storage repository 430 can be a persistent storage device (or set of devices) that stores software and data used to assist the controller 404 in communicating with the user 450, one or more other sensor devices 440, and one or more electrical devices 480 within the system 400. In one or more example embodiments, the storage repository 430 stores optional electrical device information 432, sensor information 433, and user preferences 434. The electrical device information 432 can be any information associated with an electrical device 480. Such information can include, but is not limited to, manufacturer's information of the electrical device 480, age of the electrical device 480, hours of operation of the electrical device 480, communication protocols of the electrical device 480, physical location of the electrical device 480, and orientation of the electrical device 480.

The sensor information 433 can be any sensor parameters that can be interpreted based on the various functions that can be performed by the sensor 442. Such information can include, but is not limited to, formulas and/or algorithms, functional capabilities of the sensor 442, speed of the sensor 442, physical location of the sensor 442, manufacturer of the sensor 442, manufacturer's information of the sensor 442, age of the sensor 442, hours of operation of the sensor 442, and communication protocols of the sensor 442. The sensor information 433 can also include information about the other sensors 441 of the sensor device 402, the sensor device 402 itself, and/or the other sensor devices 440 that are in communication with the sensor device 402. The user preferences 334 can be any data associated the preferences of a particular user 450.

Examples of a storage repository 430 can include, but are not limited to, a database (or a number of databases), a file system, a hard drive, flash memory, some other form of solid state data storage, or any suitable combination thereof. The storage repository 430 can be located on multiple physical machines, each storing all or a portion of the electrical device information 432, sensor information 433, and/or the user preferences 434 according to some example embodiments. Each storage unit or device can be physically located in the same or in a different geographic location.

The storage repository 430 can be operatively connected to the control engine 406. In one or more example embodiments, the control engine 406 includes functionality to communicate with the user 450, the other sensor devices 440, and the electrical devices 480 in the system 400. More specifically, the control engine 406 sends information to and/or receives information from the storage repository 430 in order to communicate with the user 450, the other sensor devices 440, and the electrical devices 480. As discussed below, the storage repository 430 can also be operatively connected to the communication module 485 in certain example embodiments.

In certain example embodiments, the controller 404 and its various components (described below) dictate which of the multiple functions that can be performed by the sensor 442 are performed by the sensor 442 at any particular point in time. The controller 404 can also generate data sent from, as well as process data received by, the sensor 442.

In certain example embodiments, the control engine 406 of the controller 404 controls the operation of one or more components (e.g., the communication module 485, the transceiver 424) of the controller 404. For example, the control engine 406 can put the communication module 485 in “sleep” mode when there are no communications between the controller 404 and another component (e.g., another electrical device 480, the user 450) in the system 400 or when communications between the controller 404 and another component in the system 400 follow a regular pattern. In such a case, power consumed by the controller 404 is conserved by only enabling the communication module 485 when the communication module 485 is needed.

The control engine 406 can provide control, communication, and/or other similar signals to the user 450, one or more other sensor devices 440, and one or more electrical devices 480. Similarly, the control engine 406 can receive control, communication, and/or other similar signals from the user 450, one or more other sensors 440, and one or more electrical devices 480. The control engine 406 can control the sensor 442 automatically (for example, based on one or more algorithms stored in the sensor information 433 of the storage repository 430) and/or based on control, communication, and/or other similar signals received from a controller of another component of the system 400 through the communication links 405. The control engine 406 may include a printed circuit board, upon which the hardware processor 420 and/or one or more discrete components of the controller 404 can be positioned.

In certain example embodiments, the control engine 406 can include an interface that enables the control engine 406 to communicate with one or more components (e.g., communication module 485) of the sensor device 402 and/or another component (e.g., an electrical device 480) of the system 400. For example, if the electrical device 480 is a light fixture, and if the power supply 438 for the sensor device 402 operates under IEC Standard 62386, then the power supply 438 can include a digital addressable lighting interface (DALI). In such a case, the control engine 406 can also include a DALI to enable communication with the power supply 438 within the sensor device 402. Such an interface can operate in conjunction with, or independently of, the communication protocols used to communicate between the controller 404 and the user 450, another sensor device 440, and an electrical device 480.

In certain example embodiments, the control engine 406 can perform diagnostic functions with respect to the sensor device 402 and/or an electrical device 480 to which the sensor device 402 is coupled. In such a case, the control engine 406 of the controller 404 can use the sensor 442 to communicate the status of the sensor device 402 and/or one or more electrical devices 480. For example, during segments of time (e.g., between time T₄ and T₅ or after time T₇ in FIG. 3) when the sensor 442 is not sending or receiving signals, the control engine 406 can use the sensor 442 to communicate the status of the sensor device 402 and/or one or more electrical devices 480.

Examples of the status of the sensor device 402 and/or one or more electrical devices 480 can include an indication of error-free communication with the user 450 (e.g., using a remote device) during start-up of an electrical device 480, status of an electrical device 480 (e.g., a luminaire) based on various fault conditions above and beyond catastrophic failure, checks for output of an electrical device 480 (e.g., light output of a luminaire), ripple conditions in the output waveform which could indicate premature failure of electrical components, and periodic testing of a sensor 442 (e.g., occupancy sensor) based on a built-in test protocols that are initiated by a user 450 (e.g., using a remote device).

The control engine 406 can operate in real time. In other words, the control engine 406 of the controller 404 can process, send, and/or receive communications with the user 450 and/or an electrical device 480, and other sensor devices 440 as any changes (e.g., discrete, continuous) occur within the system 400. Further, the control engine 406 of the controller 404 can, at substantially the same time, control the sensor device 402, another sensor device 440, and/or an electrical device 480 based on such changes. In addition, the control engine 406 of the controller 404 can perform one or more of its functions continuously. For example, the controller 404 can continuously communicate electrical device information 432, sensor information 433, and/or any other information. In such a case, any updates or changes to such information (e.g., a function performed by the sensor 442) can be used by the controller 404 in adjusting an output (e.g., current) sent by the power supply 438 to the sensor 442.

In certain example embodiments, the control engine 406 of the controller 404 can operate (e.g., in real time) based on instructions received from a user 450, based on occupancy of a space, based on the time of day and/or day of the week, and/or based on some other factor. In addition, the control engine 406 (or other portion of the controller 404) can include the timer 488. In such a case, the timer 488 can measure one or more elements of time, including but not limited to clock time and periods of time. The timer 488 can also include a calendar in addition to clock functions.

As another example, the control engine 406 can acquire the current time using the timer 488. The timer 488 can enable the controller 404 to control the switch 444 even when the controller 404 has no communication with the external controller (e.g., master controller 480). In certain example embodiments, the timer 488 can track the amount of time that the multi-functional sensor 442 is operating in a particular bias (e.g., forward bias, reverse bias). In such a case, the control engine 406 can operate a switch 444 (e.g., a relay) that changes the current bias applied to the sensor 442 by the power supply 438.

In certain example embodiments, the controller 404 receives instructions as to which functions that are to be performed by the sensor 442. Using the software stored in memory 422 and the data (e.g., algorithms) stored in the storage repository 430, the control engine 406 generates the temporal separation of those functions. For example, the control engine 406 can identify the duration and frequency that each function is performed, the order in which functions are performed, and the conditions under which a function is performed by the sensor 442. The temporal separation of the functions performed by the sensor 442 and established by the control engine 406 can be fixed or variable. If temporal separation of the functions performed by the sensor 442 is variable, any changes implemented by the control engine 406 can be based on one or more of a number of factors, including but not limited to time of day, day of week, time of year, occupancy, and range of a remote communication device (e.g., a hand-held remote operated by a user 450).

The control engine 406 (or other components of the controller 404) can also include one or more hardware and/or software architecture components to perform its functions. Such components can include, but are not limited to, a universal asynchronous receiver/transmitter (UART), a universal synchronous receiver/transmitter (USRT), a serial peripheral interface (SPI), a direct-attached capacity (DAC) storage device, an analog-to-digital converter, an inter-integrated circuit (I²C), and a pulse width modulator (PWM).

In certain example embodiments, the communication module 485 of the controller 404 determines and implements the communication protocol (e.g., from the electrical device information 432 and the sensor information 433 of the storage repository 430) that is used when the control engine 406 communicates with (e.g., sends signals to, receives signals from) the user 450, one or more of the other sensor devices 440, and/or one or more of the electrical devices 480. In some cases, the communication module 485 accesses the electrical device information 432 and/or the sensor information 433 to determine which communication protocol is within the capability of the recipient of a communication sent by the control engine 406. In addition, the communication module 485 can interpret the communication protocol of a communication received by the controller 404 so that the control engine 406 can interpret the communication.

The communication module 485 can send data directly to and/or retrieve data directly from the storage repository 430. Alternatively, the control engine 406 can facilitate the transfer of data between the communication module 485 and the storage repository 430. The communication module 485 can also provide encryption to data that is sent by the controller 404 and decryption to data that is received by the controller 404. The communication module 485 can also provide one or more of a number of other services with respect to data sent from and received by the controller 404. Such services can include, but are not limited to, data packet routing information and procedures to follow in the event of data interruption.

The timer 488 of the controller 404 can track clock time, intervals of time, an amount of time, and/or any other measure of time. The timer 488 can also count the number of occurrences of an event, whether with or without respect to time. Alternatively, the control engine 406 can perform the counting function. The timer 488 is able to track multiple time measurements concurrently. The timer 488 can track time periods based on an instruction received from the control engine 406, based on an instruction received from the user 450, based on an instruction programmed in the software for the controller 404, based on some other condition or from some other component, or from any combination thereof.

The timer 488 can be configured to track time when there is no power delivered to the controller 404 (e.g., the power module 412 malfunctions) using, for example, a super capacitor or a battery backup. In such a case, when there is a resumption of power delivery to the controller 404, the timer 488 can communicate any aspect of time to the controller 404. In such a case, the timer 488 can include one or more of a number of components (e.g., a super capacitor, an integrated circuit) to perform these functions.

The power module 412 of the controller 404 provides power to one or more other components (e.g., timer 488, control engine 406) of the controller 404. In certain example embodiments, the power module 412 receives power from the power supply 438. The power module 412 can include one or more of a number of single or multiple discrete components (e.g., transistor, diode, resistor), and/or a microprocessor. The power module 412 may include a printed circuit board, upon which the microprocessor and/or one or more discrete components are positioned. In some cases, the power module 412 can include one or more components that allow the power module 412 to measure one or more elements of power (e.g., voltage, current) that is delivered to and/or sent from the power module 412,

The power module 412 can include one or more components (e.g., a transformer, a diode bridge, an inverter, a converter) that receives power (for example, through an electrical cable) from a source (e.g., the power supply 438) and generates power of a type (e.g., alternating current, direct current) and level (e.g., 12V, 24V, 470V) that can be used by the other components of the controller 404. The power module 412 can use a closed control loop to maintain a preconfigured voltage or current with a tight tolerance at the output. The power module 412 can also protect the rest of the electronics (e.g., hardware processor 420, transceiver 424) from surges generated in the line. In addition, or in the alternative, the power module 412 can be a source of power in itself to provide signals to the other components of the controller 404. For example, the power module 412 can be a battery. As another example, the power module 412 can be a localized photovoltaic power system.

The hardware processor 420 of the controller 404 executes software in accordance with one or more example embodiments. Specifically, the hardware processor 420 can execute software on the control engine 406 or any other portion of the controller 404, as well as software used by the user 450, one or more of the sensors devices 440, and/or one or more of the electrical devices 480. The hardware processor 420 can be an integrated circuit, a central processing unit, a multi-core processing chip, a multi-chip module including multiple multi-core processing chips, or other hardware processor in one or more example embodiments. The hardware processor 420 is known by other names, including but not limited to a computer processor, a microprocessor, and a multi-core processor.

In one or more example embodiments, the hardware processor 420 executes software instructions stored in memory 422. The memory 422 includes one or more cache memories, main memory, and/or any other suitable type of memory. The memory 422 is discretely located within the controller 404 relative to the hardware processor 420 according to some example embodiments. In certain configurations, the memory 422 can be integrated with the hardware processor 420.

In certain example embodiments, the controller 404 does not include a hardware processor 420. In such a case, the controller 404 can include, as some examples, one or more field programmable gate arrays (FPGA), one or more insulated-gate bipolar transistors (IGBTs), and one or more integrated circuits (ICs). Using FPGAs, IGBTs, ICs, and/or other similar devices known in the art allows the controller 404 (or portions thereof) to be programmable and function according to certain logic rules and thresholds without the use of a hardware processor. Alternatively, FPGAs, IGBTs, ICs, and/or similar devices can be used in conjunction with one or more hardware processors 420.

The transceiver 424 of the controller 404 can send and/or receive control and/or communication signals. Specifically, the transceiver 424 can be used to transfer data between the controller 404 and the user 450, the other sensor devices 440, and/or the electrical devices 480. The transceiver 424 can use wired and/or wireless technology, using the communication links 405. The transceiver 424 can be configured in such a way that the control and/or communication signals sent and/or received by the transceiver 424 can be received and/or sent by another transceiver that is part of the user 450, the other sensors devices 440, and/or the electrical devices 480.

When the transceiver 424 uses wireless technology as the communication link 405, any type of wireless technology can be used by the transceiver 424 in sending and receiving signals. Such wireless technology can include, but is not limited to, Wi-Fi, visible light communication, cellular networking, and Bluetooth. The transceiver 424 can use one or more of any number of suitable communication protocols (e.g., ISA100, HART) when sending and/or receiving signals. Such communication protocols can be dictated by the communication module 485. Further, any transceiver information for the user 450, the other sensor devices 440, and/or the electrical devices 480 can be stored in the storage repository 430.

Optionally, in one or more example embodiments, the security module 428 secures interactions between the controller 404, the user 450, the other sensor devices 440, and/or the electrical devices 480. More specifically, the security module 428 authenticates communication from software based on security keys verifying the identity of the source of the communication. For example, user software may be associated with a security key enabling the software of the user 450 to interact with the controller 404, the other sensor devices 440, and/or the electrical devices 480. Further, the security module 428 can restrict receipt of information, requests for information, and/or access to information in some example embodiments.

By using the sensor device 402 with the example sensor 442 and in communication with a controller 404 as described herein, the sensor device 402 can use the single sensor 442 in place of multiple sensors. As a result, the sensor device 402 can have a more aesthetically appealing look and rely on fewer physical components to perform sensing functions. In addition, because of the versatility of the sensor 442, additional parameters can be measured when compared with the limited parameters that more traditional sensor devices are capable of measuring for the same relative size. Based on the information provided by the sensor 442, the controller 404 can determine the occurrence of one or more conditions within a space and cause one or more electrical devices 480 (e.g., light fixture, shade control device, fire control panel, HVAC unit, electrical receptacle) to operate. Further, example embodiments can work “out of the box”, without a user 450 having to input information, adjust settings, or otherwise manipulate the controller 404 before or during installation of the sensor device 402 and/or an electrical device 480.

One or more of the functions performed by any of the components (e.g., controller 404) of an example sensor device 402 can be performed using a computing device 518. An example of a computing device 518 is shown in FIG. 5. The computing device 518 implements one or more of the various techniques described herein, and which is representative, in whole or in part, of the elements described herein pursuant to certain example embodiments. Computing device 518 is one example of a computing device and is not intended to suggest any limitation as to scope of use or functionality of the computing device and/or its possible architectures. Neither should computing device 518 be interpreted as having any dependency or requirement relating to any one or combination of components illustrated in the example computing device 518.

Computing device 518 includes one or more processors or processing units 514, one or more memory/storage components 515, one or more input/output (I/O) devices 516, and a bus 517 that allows the various components and devices to communicate with one another. Bus 517 represents one or more of any of several types of bus structures, including a memory bus or memory controller, a peripheral bus, an accelerated graphics port, and a processor or local bus using any of a variety of bus architectures. Bus 517 includes wired and/or wireless buses.

Memory/storage component 515 represents one or more computer storage media. Memory/storage component 515 includes volatile media (such as random access memory (RAM)) and/or nonvolatile media (such as read only memory (ROM), flash memory, optical disks, magnetic disks, and so forth). Memory/storage component 515 includes fixed media (e.g., RAM, ROM, a fixed hard drive, etc.) as well as removable media (e.g., a Flash memory drive, a removable hard drive, an optical disk, and so forth).

One or more I/O devices 516 allow a customer, utility, or other user to enter commands and information to computing device 518, and also allow information to be presented to the customer, utility, or other user and/or other components or devices. Examples of input devices include, but are not limited to, a keyboard, a cursor control device (e.g., a mouse), a microphone, and a scanner. Examples of output devices include, but are not limited to, a display device (e.g., a monitor or projector), speakers, a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 518 is connected to a network (not shown) (e.g., a local area network (LAN), a wide area network (WAN) such as the Internet, or any other similar type of network) via a network interface connection (not shown) according to some example embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other example embodiments. Generally speaking, the computer system 518 includes at least the minimal processing, input, and/or output means necessary to practice one or more embodiments.

Further, those skilled in the art will appreciate that one or more elements of the aforementioned computer device 518 is located at a remote location and connected to the other elements over a network in certain example embodiments. Further, one or more embodiments is implemented on a distributed system having one or more nodes, where each portion of the implementation (e.g., controller 404) is located on a different node within the distributed system. In one or more embodiments, the node corresponds to a computer system. Alternatively, the node corresponds to a processor with associated physical memory in some example embodiments. The node alternatively corresponds to a processor with shared memory and/or resources in some example embodiments.

Example embodiments provide a number of benefits. Examples of such benefits include, but are not limited to, reduction in visible footprint; more simplistic installation, replacement, modification, and maintenance of a sensor device; improved aesthetics; ability to transmit energy waves in two directions rather than just one direction; compliance with one or more applicable standards and/or regulations; lower maintenance costs, increased flexibility in system design and implementation; and reduced cost of labor and materials. Example embodiments can be used for installations of new electrical devices and/or new sensor devices. Example embodiments can also be integrated (e.g., retrofitted) with existing electrical devices and/or sensor devices.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A sensor device comprising:
a sensor having a first mode of operation and a second mode of operation, wherein the sensor, when in the first mode of operation, transmits a first plurality of signals during a first period of time, and wherein the sensor, when in the second mode of operation, receives a second plurality of signals during a second period of time.

2. The sensor device of claim 1, wherein the first period of time and the second period of time avoid overlapping each other.

3. The sensor device of claim 1, wherein the second period of time begins at substantially the same time as when the first period of time ends.

4. The sensor device of claim 1, wherein the first period of time and the second period of time alternate based on a fixed schedule.

5. The sensor device of claim 1, wherein the first plurality of signals have a first range of frequencies, and wherein the second plurality of signals have a second range of frequencies.

6. The sensor device of claim 5, wherein the first range of frequencies and second range of frequencies avoid overlapping each other.

7. The sensor device of claim 1, wherein the sensor is a light-emitting diode.

8. The sensor device of claim 1, wherein the first period of time corresponds to a first function, and wherein the second period of time corresponds to a second function.

9. The sensor device of claim 8, wherein the first function comprises at least one selected from a group consisting of transmitting a communication to a receiver and emitting light.

10. The sensor device of claim 8, wherein the second function comprises at least one selected from a group consisting of occupancy detection, daylight detection, and receiving a communication from a remote control device.

11. The sensor device of claim 1, wherein a forward bias is applied to the sensor during the first period of time, and wherein a reverse bias is applied to the sensor during the second period of time.

12. The sensor device of claim 1, wherein the sensor further has a third mode of operation, wherein the sensor, in the third mode of operation, receives a third plurality of signals during a third period of time.

13. The sensor device of claim 12, wherein the first period of time, the second period of time, and the third period of time avoid overlapping each other.

14. The sensor device of claim 1, further comprising:
a controller communicably coupled to the sensor, wherein the controller temporally separates the first mode of operation and the second mode of operation.

15. The sensor device of claim 14, wherein the controller is configured to control a functional component of an electrical device based on the first plurality of signals and the second plurality of signals.

16. The sensor device of claim 15, further comprising:
at least one switch coupled to the controller and the sensor, wherein the controller operates the switch to toggle between the first mode of operation and the second mode of operation.

17. The sensor device of claim 16, further comprising:
a power supply coupled to the at least one switch and the sensor, wherein the power supply provides a forward bias to the sensor when the at least one switch is in a first position, and wherein the power supply provides a reverse bias to the sensor when the at least one switch is in a second position.

18. A sensor for a sensor device, the sensor comprising:
a light-emitting diode (LED) having a first mode of operation and a second mode of operation, wherein the LED, when in the first mode of operation, transmits a first plurality of signals during a first period of time, and wherein the sensor, when in the second mode of operation, receives a second plurality of signals during a second period of time.

19. The sensor of claim 18, wherein the LED switches between the first mode of operation and the second mode of operation by a controller of the sensor device.

20. An electrical device, comprising:
a functional component;
a controller coupled to the functional component; and
a sensor device coupled to the controller, wherein the sensor device comprises:
a sensor having a first mode of operation and a second mode of operation, wherein the sensor, when in the first mode of operation, transmits a first plurality of signals during a first period of time, and wherein the sensor, when in the second mode of operation, receives a second plurality of signals during a second period of time,
wherein the controller controls the functional component based on the first plurality of signals and the second plurality of signals.
